(19) United States
(12) Patent Application Publication
(10) Pub. No.: US 2026/0142692 A1
(43) Pub. Date: May 21, 2026

(54) CONTROL OF A REFLECTIVE INTELLIGENT SURFACE

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(73) Assignee: Telefonaktiebolaget LM Ericsson (publ), Stockholm (SE)

(21) Appl. No.: 19/114,695

(22) PCT Filed: Sep. 28, 2022
(86) PCT No.: PCT/EP2022/076972

§ 371 Date: Mar. 24, 2025

(51) Int. Cl. H04B 7/04

(52) U.S. Cl. CPC H04B 7/04013

(57) ABSTRACT

There is provided techniques for controlling an RIS. The RIS comprises a controller entity and a reflector entity. The reflector entity is associated with configurable reflection properties defining how radio waves that impinge the reflector entity are reflected. The reflection properties are controlled by the controller entity. A method is performed by a network node. The method comprises determining that the RIS to refrain from reflecting signals communicated in radio waves between the network node and a user equipment. The method comprises, in response thereto, providing an indication to the controller entity for the RIS to enter a non-relay mode according to which the reflector entity is to apply a default configuration of the reflection properties.

### TECHNICAL FIELD

Embodiments presented herein relate to methods, a network node, a controller entity, computer programs, and a computer program product for controlling a reflective intelligent surface.

### BACKGROUND

A reconfigurable intelligent surface (RIS) offers an opportunity for improved wireless communication. Specifically, significant gains are envisioned to be made for millimeter wave spectrum, which is the spectrum used in fifth generation and sixth generation telecommunication systems. This spectrum has serious challenges when it comes to propagation and coverage, e.g., due to its support for very high frequency ranges in tens of GHz. The challenges are larger compared to challenges for spectrum with lower frequencies e.g., for so-called sub-6GHZ frequency bands.

RISs represent an emerging technology that is capable of intelligently manipulating the propagation of electro-magnetic waves. A RIS is commonly also referred to as a large intelligent surface, a smart reflect-array, an intelligent reflecting surface, a passive intelligent mirror, an artificial radio space, and a meta-surface.

In general terms, a RIS is composed of a 2-dimensional array of reflecting antenna elements, such as patch antennas, where each antenna element acts as a passive reconfigurable scatterer, i.e., a piece of manufactured material, which can be programmed to change an impinging electro-magnetic wave in a customizable way. Such antenna elements are commonly provided as low-cost passive surfaces that do not require dedicated power sources, and the radio waves impinged upon them can be forwarded without the need of employing power amplifier or radio chain. Moreover, a RIS can, potentially, operate in full duplex mode without significant self-interference or increased noise level and requires only low-rate control link or backhaul connections. A RIS can be flexibly deployed due to its low weight and low power consumption.

FIG. 1 is a schematic illustration of an example RIS 140. The RIS 140 comprises a controller entity 300 and a reflector entity 110, comprising a meta-surface or other type of array structure with reflecting antenna elements 160. The controller entity 300 is configured to control the reflection angle of the reflector entity 110 for reflecting radio waves over an indirect link 130a, 130b, such as between a network node and one or more user equipment. The controller entity 300 further is provided with transceiver circuitry for receiving instructions from the network node over a control channel (as indicated by the link 150 which could be either wired or wireless) regarding how the reflection angle of the reflector entity 110 is to be controlled. In further detail, by the controller entity 300 controlling the impedances of the respective reflecting antenna elements 160, the reflection angle Or of an incoming radio wave, having an inclination angle θi, can be adapted according to the generalized Snell's law. Fig, 1 only illustrates one example implementation of the RIS 140 and the implementation might differ dependent on the type of RIS 140. Usage of the RIS can vary, but in general the RIS can be configured to reflect wireless signals in a controlled manner, e.g., to steer transmitted signals in a certain direction. This could for example be used to improve overall system coverage, range, and efficiency.

FIG. 2 is a schematic diagram illustrating a communication network 100a where a RIS 140 is shown as facilitating communication between a network node 200a and a user equipment 120a over wireless links 130a, 130b. This could represent a scenario where a physical object obstructs the line of sight between the network node 200a and the user equipment 120a. Other scenarios of usage could include an RIS being part of, or connected to, a wireless device, for enhancing communication for the user equipment 120a. As is further illustrated in FIG. 2, the network node 200a serves another user equipment 120b over a direct wireless link 132, and a further network node 200b serves a user equipment 120c over another direct wireless link 134.

One issue when using a RIS 140 as in the example of FIG. 2 is interference management. Particularly, different from a network-controlled repeater (or other types of nodes) which is turned off when its service is not required, when the RIS 140 is not actively used by any of the network nodes 200a, 200b, the RIS 140 might still reflect incoming signals in different directions. Indeed, this is not desired, as it increases the network interference. This is an effect of that the RIS 140 cannot be completely and fully turned off.

One way to mitigate this issue would be to physically cover the reflector entity 110 of the RIS 410 when the RIS 140 is not actively used. However, this would require either the RIS 140 to be provided with some movable mechanical structure to accomplish this covering, or that maintenance personnel is called out to perform the duty of physically covering the reflector entity 110 when needed. Adding movable mechanical structure increases the mechanical complexity and operation of the RIS. Sending out maintenance personnel requires careful planning of when the RIS is to be active and inactive, respectively, which might cumbersome or even impossible to predict in case the served user equipment are movable.

Hence, there is still a need for improved control of an RIS, especially when the RIS is to not reflect signals communicated in radio waves between a network node and a user equipment.

### SUMMARY

An object of embodiments herein is to address the above issues and to provide efficient control of the RIS such that the above issues can be avoided or at least mitigated or reduced.

A particular object of embodiments herein is to address issues occurring when a RIS is to not intended to reflect signals communicated in radio waves between a network node and a user equipment.

According to a first aspect there is presented a method for controlling an RIS. The RIS comprises a controller entity and a reflector entity. The reflector entity is associated with configurable reflection properties defining how radio waves that impinge the reflector entity are reflected. The reflection properties are controlled by the controller entity. The method is performed by a network node. The method comprises determining that the RIS to refrain from reflecting signals communicated in radio waves between the network node and a user equipment. The method comprises, in response thereto, providing an indication to the controller entity for the RIS to enter a non-relay mode according to which the reflector entity is to apply a default configuration of the reflection properties.

According to a second aspect there is presented a network node for controlling an RIS. The RIS comprises a controller entity and a reflector entity. The reflector entity is associated with configurable reflection properties defining how radio waves that impinge the reflector entity are reflected. The reflection properties are controlled by the controller entity. The network node comprises processing circuitry. The processing circuitry is configured to cause the network node to determine that the RIS to refrain from reflecting signals communicated in radio waves between the network node and a user equipment. The processing circuitry is configured to cause the network node to, in response thereto, provide an indication to the controller entity for the RIS to enter a non-relay mode according to which the reflector entity is to apply a default configuration of the reflection properties.

According to a third aspect there is presented a network node for controlling an RIS. The RIS comprises a controller entity and a reflector entity. The reflector entity is associated with configurable reflection properties defining how radio waves that impinge the reflector entity are reflected. The reflection properties are controlled by the controller entity. The network node comprises a determine module configured to determine that the RIS to refrain from reflecting signals communicated in radio waves between the network node and a user equipment. The network node comprises a provide module configured to, in response thereto, provide an indication to the controller entity for the RIS to enter a non-relay mode according to which the reflector entity is to apply a default configuration of the reflection properties.

According to a fourth aspect there is presented a computer program for controlling an RIS, the computer program comprising computer program code which, when run on processing circuitry of a network node, causes the network node to perform a method according to the first aspect.

According to a fifth aspect there is presented a method for controlling an RIS. The RIS comprises a controller entity and a reflector entity. The reflector entity is associated with configurable reflection properties defining how radio waves that impinge the reflector entity are reflected. The reflection properties are controlled by the controller entity. The method is performed by the controller entity. The method comprises obtaining an indication that the RIS is to enter a non-relay mode according to which the reflector entity is to refrain from reflecting signals communicated in radio waves between a network node and a user equipment. The method comprises, in response thereto, configuring the reflector entity to apply a default configuration of the reflection properties.

According to a sixth aspect there is presented a controller entity for controlling an RIS. The RIS comprises the controller entity and a reflector entity. The reflector entity is associated with configurable reflection properties defining how radio waves that impinge the reflector entity are reflected. The reflection properties are controlled by the controller entity. The controller entity comprises processing circuitry. The processing circuitry is configured to cause the controller entity to obtain an indication that the RIS is to enter a non-relay mode according to which the reflector entity is to refrain from reflecting signals communicated in radio waves between a network node and a user equipment. The processing circuitry is configured to cause the controller entity to, in response thereto, configure the reflector entity to apply a default configuration of the reflection properties.

According to a seventh aspect there is presented a controller entity for controlling an RIS. The RIS comprises the controller entity and a reflector entity. The reflector entity is associated with configurable reflection properties defining how radio waves that impinge the reflector entity are reflected. The reflection properties are controlled by the controller entity. The controller entity comprises an obtain module configured to obtain an indication that the RIS is to enter a non-relay mode according to which the reflector entity is to refrain from reflecting signals communicated in radio waves between a network node and a user equipment. The controller entity comprises a configure module configured to, in response thereto, configure the reflector entity to apply a default configuration of the reflection properties.

According to an eighth aspect there is presented a computer program for controlling an RIS, the computer program comprising computer program code which, when run on processing circuitry of a controller entity, causes the controller entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient control of the RIS and do not suffer from the above identified issues.

Advantageously, these aspects provide an efficient configuration scheme for the RIS. Particularly, the RIS is configured with default configuration when its operation is not needed for reflecting signals communicated in radio waves between the network node and user equipment served by the network node.

Advantageously, these aspects can be used for interference management.

Considering the signals received from different nodes and possibly on adjacent carriers, the default configuration can be set such that network interference is minimized. This results in proper integration of the RIS into the network, coverage extension and a fairly constant quality of service experience for the served user equipment.

Advantageously, these aspects can be used for self-calibration of the network node.

With a proper configuration of an inactive IRS, the RIS can be utilized for self-calibration of the network node. As a result, coordination between different network nodes is not required when one of the network nodes is to perform self-calibration. This in turn reduces the calibration overhead.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise.

The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating an RIS according to embodiments;

FIG. 2 is a schematic diagram illustrating a communication network according to embodiments;

FIGS. 3 and 4 are flowcharts of methods according to embodiments;

FIG. 5 is a schematic illustration of communication networks with different reflection states of an RIS according to embodiments;

FIG. 6 is a schematic diagram showing functional units of a network node according to an embodiment;

FIG. 7 is a schematic diagram showing functional modules of a network node according to an embodiment;

FIG. 8 is a schematic diagram showing functional units of a controller entity according to an embodiment;

FIG. 9 is a schematic diagram showing functional modules of a controller entity according to an embodiment; and

FIG. 10 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

At least some of the herein disclosed embodiments address issues with inactive RISs, i.e., RISs that, at the moment, are not intended to be used for reflecting signals communicated in radio waves between the network node and user equipment served by the network node. Hence, by a RIS being inactive refers to the case where, for instance, an RIS is not utilized to assist data transmission to/from a user equipment, or not utilized to relay other kind of signals, for example reference signals or random access signals.

As disclosed above, interference management is one issue when using a RIS and it may affect how RISs are integrated into future wireless networks. Particularly, to guarantee proper integration and operation of an RIS as well as reliable network-level performance, beam management schemes need to be designed such that the RIS does not introduce severe additional interference to the network or other networks operating in the same frequency band.

Different from typical network nodes, e.g., integrated access and backhaul (IAB) nodes, repeaters, or even user equipment for that matter, which receive a signal from a parent network node as an end point and possibly forwards the received signal with proper scheduling and active amplification, etc., RISs directly reflect the received signals with, e.g., some phase rotation. In other words, a RIS has as such not any dedicated active status, state, or mode, and likewise not any dedicated inactive status, status, or mode as the RIS will always reflect an impinging radio wave. Thus, that a RIS is inactive could imply that reflections may take place in a non-controlled, or non-intended way. This is not desirable from a network-level perspective as it may end up in severe interference in specific directions and, thereby, affect the achievable rates of the rest of the network or even adjacent networks. This is especially important because an RIS may receive signals in different beams from the same and different network nodes, and it may not be known to the RIS when the signals will appear.

According to at least some of the herein disclosed embodiments, the above issues are addressed by intruding a default configuration for the reflection properties of the RIS. Different examples of how such a default configuration can be realized will be provided in the following. Along with interference management, the default configuration can be used to simplify self-calibration. In practice, each network node needs to perform calibrations either at regular time intervals or when otherwise triggered to do so. One calibration scheme involves network nodes to pairwise cooperate during calibration, for example using bi-directional sounding, where calibration signals are transmitted between the cooperating network nodes. Such bi-directional sounding, or other form of cooperation among the network nodes can be avoided if instead the RIS is used to reflect signals back to the network nodes, thus facilitating self-calibration of the network node.

The embodiments disclosed herein thus relate to techniques for controlling an RIS 140. In order to obtain such techniques there is provided a network node 200a, a method performed by the network node 200a, a computer program product comprising code, for example in the form of a computer program, that when run on processing circuitry of the network node 200a, causes the network node 200a to perform the method. In order to obtain such techniques there is further provided a controller entity 300, a method performed by the controller entity 300, and a computer program product comprising code, for example in the form of a computer program, that when run on processing circuitry of the controller entity 300, causes the controller entity 300 to perform the method.

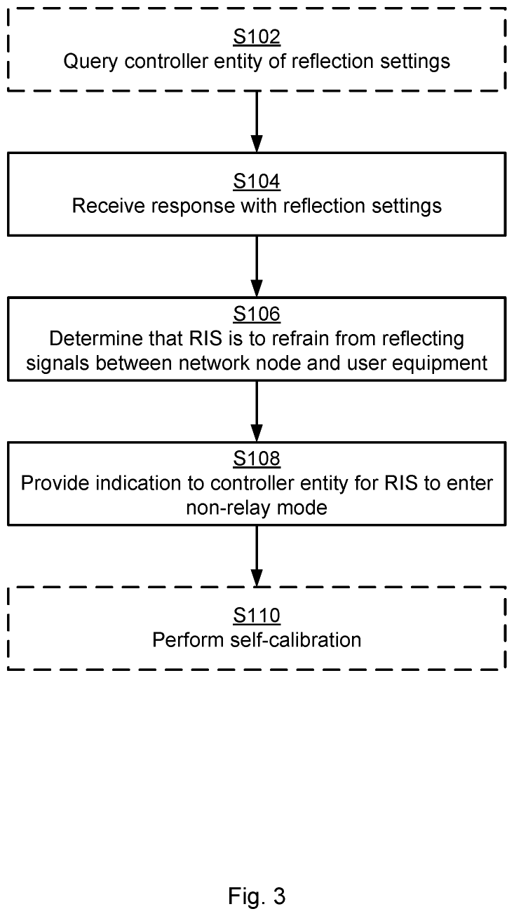

Reference is now made to FIG. 3 illustrating a method for controlling an RIS 140 as performed by the network node 200a according to an embodiment. The RIS 140 comprises a controller entity 300 and a reflector entity 110. In some aspects the controller entity 300 implements a mobile termination (MT). The reflector entity 110 is associated with configurable reflection properties defining how radio waves that impinge the reflector entity 110 are reflected. The reflection properties are controlled by the controller entity 300.

S106: The network node 200a determines that the RIS 140 to refrain from reflecting signals communicated in radio waves between the network node 200a and a user equipment 120a.

S108: The network node 200a, in response thereto, provides an indication to the controller entity 300 for the RIS 140 to enter a non-relay mode according to which the reflector entity 110 is to apply a default configuration of the reflection properties.

A default configuration is thereby determined that is safe in terms of interference or useful for self-calibration of the network node 200a.

In this way the RIS can be well integrated into the network and additional severe interference caused by the RIS can be avoided. This results in better network-level performance and, thereby, fairly constant quality-of-service for the served user equipment. Further, utilizing the default configuration for self-calibration of the network node 200a reduces the calibration overhead.

Embodiments relating to further details of controlling an RIS 140 as performed by the network node 200a will now be disclosed.

In some aspects the network node 200a selects which default configuration the reflector entity 110 is to apply based on properties, or capabilities, of the reflector entity 110. For this purpose, the network node 200a might query the controller entity 300 of such properties, or capabilities. In particular, in some embodiments, the network node 200a is configured to perform (optional) step S102.

S102: The network node 200a queries the controller entity 300 for possible reflection settings that the reflector entity 110 according to the reflection properties is capable of applying.

In general terms, the possible reflection settings define the properties, or capabilities, of the reflector entity 110. Examples of reflection settings will be disclosed below.

It is assumed that the controller entity 300 responds back to the network node 200a with the possible reflection settings and hence that the network node 200a is configured to perform (optional) step S104. S104: The network node 200a receives a response from the controller entity 300 comprising the reflection settings, where the default configuration is selected to correspond to one of the reflection settings.

In some non-limiting examples, the reflection settings define any of: a set of reflection angles, a set of reflection beam widths, scattering capabilities of the reflector entity 110.

In some aspects, the reflection settings are provided as a set of RIS states, and where the indication in step S108 identifies one of the RIS states for the RIS 140 to use.

In some aspects, the network node 200a provides an explicit indication that the RIS 140 will not be used for certain periodic, semi-persistent, or dynamic, time slots. Therefore, in some embodiments, the indication in step S108 comprises information of a time period during which the RIS 140 is to be in the non-relay mode. This time period might be based on some semi-static, or semi-persistent, transmissions at the network node 200a, such as transmission of refence signals (such as synchronization signal block (SSB) signals, channel state information reference signals (CSI-RS)), system information (such as system information block 1(SIB1 )), etc.

Aspects relating to properties of the default configuration will be disclosed next.

In some aspects, the default configuration is selected according to which the reflector entity 110 is to use as wide beams as possible or yield non-coherent reflections (e.g., by phase randomization such that constructive reflections from all antenna elements are avoided) or where the reflection beams are selected based on a mathematical optimization problem, e.g., according to a minimization of the maximum reflection beam, possibly also considering an inclination angle from a known source. Default configurations fulfilling any of these principles could be useful for interference management and/or self-calibration of the network node 200a (or another network node 200b), whenever the RIS is not needed for reflecting signals communicated in radio waves between the network node 200a and its served user equipment 120a, 120b.

In some aspects, the default configuration is defined by a scatter mode according to which there is no coherent reflection from the RIS. That is, scattering is a state in which the IRS reflects a minimum amount of coherent energy in any given direction. This corresponds to distributing the reflected energy in as many directions as possible. Therefore, in some embodiments, the reflector entity 110 is configured to reflect the radio waves in reflection beams, and the default configuration specifies the reflector entity 110 to use as wide reflection beam as possible.

In some aspects, the default configuration is determined based on that the RIS should provide enough coverage in the area targeted for the RIS, such that user equipment can perform initial access in the area targeted for the RIS. Such a default configuration is useful when the RIS is supposed to provide (semi)-static coverage in a specific area (e.g., blind spot) and facilitates the use of RIS when required. Statistical measurements can be used during a significant time period, to determine the suitable default configuration.

In some aspects, the default configuration is determined for the reflector entity 110 to have randomly selected reflection coefficients, resulting in non-coherent reflections. Another way to achieve this is to use mathematical optimization, e.g., a minimax optimization, such that the maximum reflection direction is minimized in amplitude. In particular, in some embodiments, the reflector entity 110 comprises reflecting antenna elements 160 in which the radio waves are reflected and the default configuration specifies the reflection elements to have uncorrelated reflection angles.

In some embodiments, the default configuration specifies a default reflection angle and beam width.

In some aspects, the default reflection angle is determined as a function of the positions of user equipment (as well as other entities) that should not be interfered, the position/direction of the RIS, information of beam pointing directions of different RIS configurations. In particular, in some embodiments, the default reflection angle is by the network node 200a determined based on positioning information of at least one of the network node 200a, the RIS 140, and user equipment 120a, 120b served by the network node 200a. The default reflection angle can thereby be selected to define a narrow beam that points away from the directions of the user equipment under consideration. In some examples, the network node 200a also knows the position of network node 220b and its served user equipment 120c, and the RIS 140 can be configured to not reflect signals originating from network node 200a towards user equipment 120c or from network node 200b towards user equipment 120a and 120b. In related aspects, the default reflection angle is determined by finding a safe reflection angle not affecting operation of other network nodes. Therefore, in some embodiments the default reflection angle is by the network node 200a determined, based on the positioning information, with an object for the RIS 140 to avoid reflecting radio waves towards the network node 200a and/or the user equipment 120a. The position information might, for example, be provided in terms of a map comprising the positions of network node 200a, 200b and the RIS 140, possible also other stationary physical objects, such as houses, walls, etc. that might reflect radio waves.

In some aspects, the default reflection angle is determined based on minimizing the generated interference towards user equipment 120a, 120b served by the network node 200a using multi-user multiple-input multiple-output (MU-MIMO) operation. That is, in some embodiments, the default reflection angle is by the network node 200a determined for the network node 200a to use MU-MIMO operation without the RIS 140 acting as relay node.

In some aspects, the default reflection angle is determined based on evaluating candidate reflection angles as realized by the RIS when the network node 200a is measuring on uplink reference signals (such as sounding reference signals, SRS) transmitted by the user equipment 120a, 120b served by the network node 200a. The network node 200a might then determine the reflection angle as the candidate reflection angle that minimizes the received uplink power of the uplink reference signals. In particular, in some embodiments, the default reflection angle is by the network node 200a determined based on reports from user equipment 120a, 120b served by the network node 200a of reference signals transmitted in beams from the network node 200a.

In related aspects, the default reflection angle is determined based on measurement reports received by the network node 200a from surrounding network nodes 200b, by using the measurements on uplink reference signals from user equipment 120c served by the surrounding network nodes 200b. Hence, in some embodiments, the default reflection angle is by the network node 200a determined based on measurements made by the network node 200a on reference signals received by the network node 200a from user equipment 120c served by at least one further network node 200b.

In further related aspects, the default reflection angle is determined based on interference to adjacent networks and on adjacent carriers. That is, in some embodiments, the default reflection angle is by the network node 200a determined based on estimated interference as caused by the RIS 140 to at least one further network node 200b.

One possible default configuration is the one that minimizes reflections in directions to which the RIS has recently been configured to reflect. Hence, in some embodiments, the default configuration specifies a direction of arrival and that direction of departure for the radio waves reflected by the reflector entity 110 to be same as the direction of arrival. Hence, the reflection angle yielding a reflection beam that maximizes the antenna gain in the same direction as the direction of arrival can be selected as the default reflection angle.

In further aspects, to facilitate self-calibration, the RIS might be configured to by-default reflect an incoming signal in the same direction as the incoming signal. Then, a network node 200a, 200b can use the RIS for self-calibration. Hence, in some embodiments, the network node 200a is configured to perform (optional) step S110.

S110: The network node 200a performs self-calibration of the network node 200a by transmitting a signal to be reflected back to the network node 200a via the RIS 140.

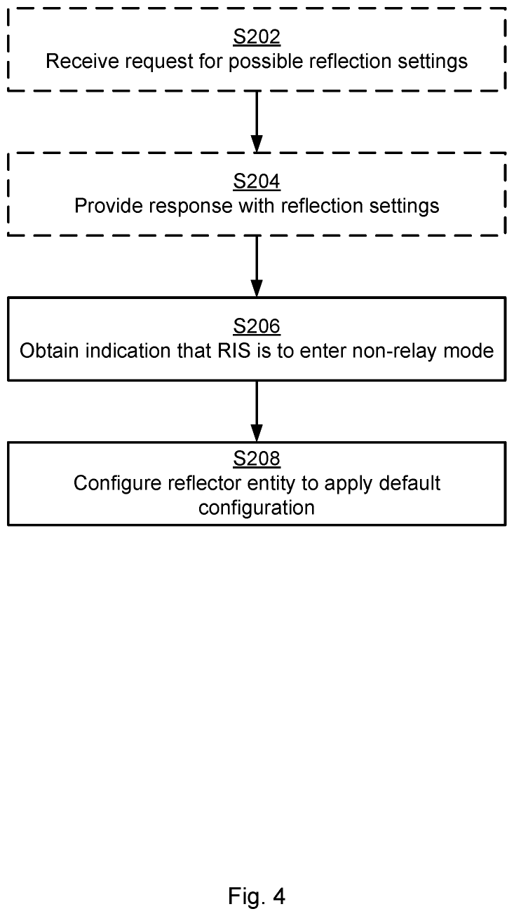

Reference is now made to FIG. 4 illustrating a method for controlling an RIS 140 as performed by the controller entity 300 according to an embodiment. The RIS 140 comprises a controller entity 300 and a reflector entity 110. The reflector entity 110 is associated with configurable reflection properties defining how radio waves that impinge the reflector entity 110 are reflected. The reflection properties are controlled by the controller entity 300.

S206: The controller entity 300 obtains an indication that the RIS 140 is to enter a non-relay mode according to which the reflector entity 110 is to refrain from reflecting signals communicated in radio waves between a network node 200a and a user equipment 120a.

S208: The controller entity 300, in response thereto, configures the reflector entity 110 to apply a default configuration of the reflection properties.

Embodiments relating to further details of controlling an RIS 140 as performed by the controller entity 300 will now be disclosed.

Aspects relating to how the indication might be obtained by the controller entity 300 in step S206 will eb disclosed next.

The indication obtained in step S206 might either be explicit or implicit. In some aspects, the RIS could be assumed to be un-scheduled in periodic, semi-persistent or dynamic time slots where the RIS has not been explicitly configured with an RIS state. This is an example where the indication is implicit. In particular, in some embodiments, the indication is obtained by means of the controller entity 300 entering a specific time period, or by the controller entity 300 having identified an absence of expected reception of configuration from the network node 200a. In other embodiments, the indication is obtained by being received from the network node 200a. This is an example where the indication is explicit.

For example, the controller entity 300 could receive an explicit indication from the network node 200a that the RIS 140 will not be used for certain periodic, semi-persistent or dynamic time slots. Hence, in some embodiments, the indication comprises information of a time period during which the RIS 140 is to be in the non-relay mode. In this way, a default configuration is obtained for the RIS and its idle periods are determined, such that the RIS does not introduce unexpected interference to the network when the RIS is not involved in the data transmission.

As disclosed above, the network node 200a might query the controller entity 300 for possible reflection settings of the reflector entity 110. Therefore, in some embodiments, the controller entity 300 is configured to perform (optional) steps S202, S204.

S202: The controller entity 300 receives a request from the network node 200a for possible reflection settings that the reflector entity 110 according to the reflection properties is capable of applying.

S204: The controller entity 300 provides a response to the network node 200a comprising the reflection settings, and wherein the indication identifies one of the reflection settings.

As disclosed above, in some non-limiting examples, the reflection settings define any of: a set of reflection angles, a set of reflection beam widths, scattering capabilities of the reflector entity 110.

As disclosed above, in some embodiments, the reflector entity 110 is configured to reflect the radio waves in reflection beams, and the default configuration specifies the reflector entity 110 to use as wide reflection beam as possible.

As disclosed above, in some embodiments, the reflector entity 110 comprises reflecting antenna elements 160 in which the radio waves are reflected, and the default configuration specifies the reflection elements to have uncorrelated reflection angles.

As disclosed above, in some embodiments, the default configuration specifies a default reflection angle.

As disclosed above, in some embodiments, the default configuration specifies a direction of arrival and that radio waves received from the network node 200a are to be reflected back towards the network node 200a.

In related aspects, the indication obtained in step S206 comprises a physical cell identity (PCI) of a network node 200b towards which the radio waves are to be reflected. That is in some embodiments, the indication comprises a PCI of a further network node 200b, and the default configuration corresponds to reflecting the radio waves received from the further network node 200b back towards said further network node 200b. This enables the further network node 200b to perform self-calibration.

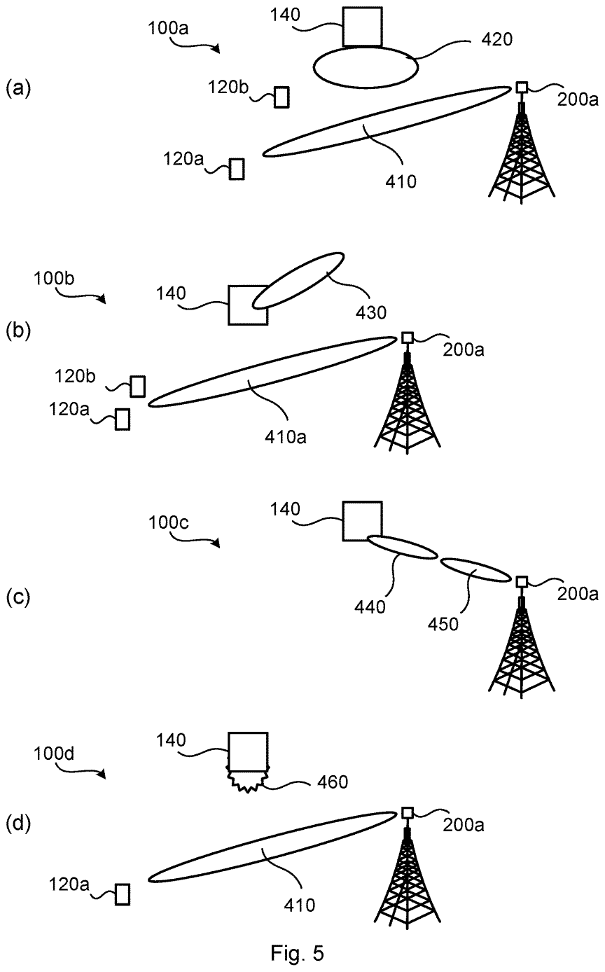

Reference is next made to FIG. 5 which schematically illustrates different examples of default configurations and/or default reflection angles as deployed by the RIS 140. In FIG. 5 is illustrated different scenarios of a communication network 100b, 100c, 100d, 100e where a network node 200a is serving one or more user equipment 120a, 120b but where the RIS 140 is not to act as a relay for reflecting signals communicated in radio waves between the network node 200a and the one or more user equipment 120a. 120b. In FIG. 5(a), 5(b), and 5(d) the network node 200a is communicating with one or more user equipment 120a, 120b in a beam 410. In FIG. 5(a) is illustrated an example where the default configuration corresponds to the RIS being configured with using as wide beam 420 as possible for reflecting incoming signals. This could be useful if the served user equipment 120a, 120b are geographically spread over the serving region of the network node 200a. In FIG. 5(b) is illustrated an example where the default configuration corresponds to the RIS being configured with a default reflection angle, where the default reflection angle is selected such that the resulting reflection beam 430 realized by the RIS does not affect transmission between the network node 200a and the one or more user equipment 120a, 120b. That is, the default reflection angle is selected such that beam 430 points away from the user equipment 120a, 120b. This could be useful if the served user equipment 120a, 120b are located close together. In FIG. 5(c) is illustrated an example where the default configuration corresponds to the RIS being configured with a default reflection angle yielding a beam 440 pointing back towards the network node 200a such that the network node 200a can utilize the RIS 140 as part of self-calibration, by sending signals in a beam 450 that are reflected back to the network node 200a via beam 440. In FIG. 5(d) is illustrated an example where the default configuration corresponds to the RIS being configured with a beam 460 having a spatial radiation pattern designed to minimize the reflection angles.

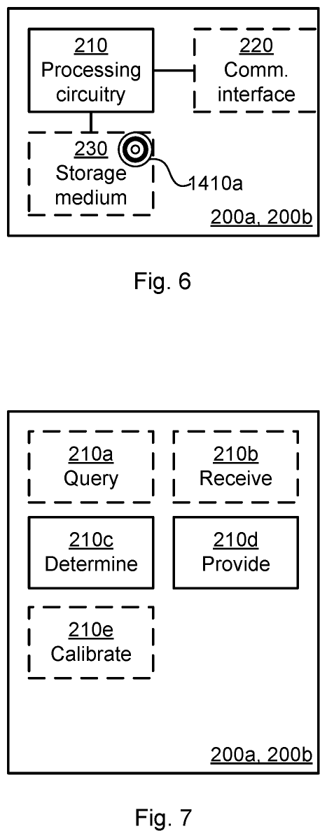

FIG. 6 schematically illustrates, in terms of a number of functional units, the components of a network node 200a, 200b according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1010a (as in FIG. 10), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200a, 200b to perform a set of operations, or steps, as disclosed above. For example, the storage medium 230 may store the set of operations, and the processing circuitry 210 may be configured to retrieve the set of operations from the storage medium 230 to cause the network node 200a, 200b to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

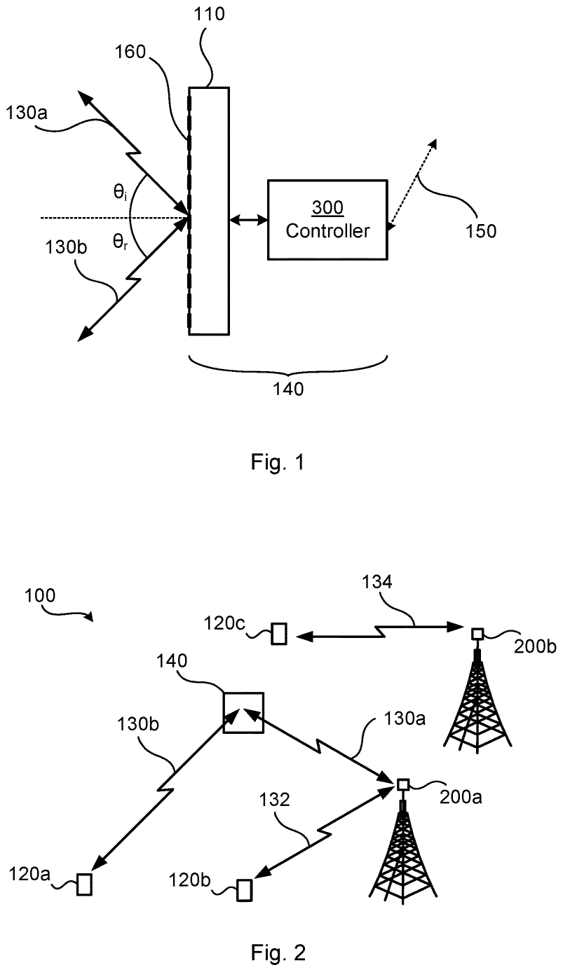

The network node 200a, 200b may further comprise a communications interface 220 for communications with other entities, functions, nodes, and devices, as in FIG. 1 and FIG. 2. As such the communications interface 220 may comprise one or more transmitters and receivers, comprising analogue and digital components.

The processing circuitry 210 controls the general operation of the network node 200a, 200b e.g. by sending data and control signals to the communications interface 220 and the storage medium 230, by receiving data and reports from the communications interface 220, and by retrieving data and instructions from the storage medium 230. Other components, as well as the related functionality, of the network node 200a, 200b are omitted in order not to obscure the concepts presented herein.

FIG. 7 schematically illustrates, in terms of a number of functional modules, the components of a network node 200a, 200b according to an embodiment. The network node 200a, 200b of FIG. 7 comprises a number of functional modules; a determine module 210c configured to perform step S106, and a provide module 210d configured to perform step S108. The network node 200a, 200b of FIG. 7 may further comprise a number of optional functional modules, such as any of a query module 210a configured to perform step S102, a receive module 210b configured to perform step S104, and a calibrate module 210e configured to perform step S110. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any steps of the network node 200a, 200b as disclosed herein.

The network node 200a, 200b may be provided as a standalone device or as a part of at least one further device. For example, the network node 200a, 200b may be provided in a node of a radio access network or in a node of a core network. Alternatively, functionality of the network node 200a, 200b may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200a, 200b may be executed in a first device, and a second portion of the instructions performed by the network node 200a, 200b may be executed in a second device; the herein disclosed embodiments are not limited to any particular number of devices on which the instructions performed by the network node 200a, 200b may be executed. Hence, the methods according to the herein disclosed embodiments are suitable to be performed by a network node 200a, 200b residing in a cloud computational environment. Therefore, although a single processing circuitry 210 is illustrated in FIG. 6, the processing circuitry 210 may be distributed among a plurality of devices, or nodes. The same applies to the functional modules 210a:210e of FIG. 7 and the computer program 1020a of FIG. 10.

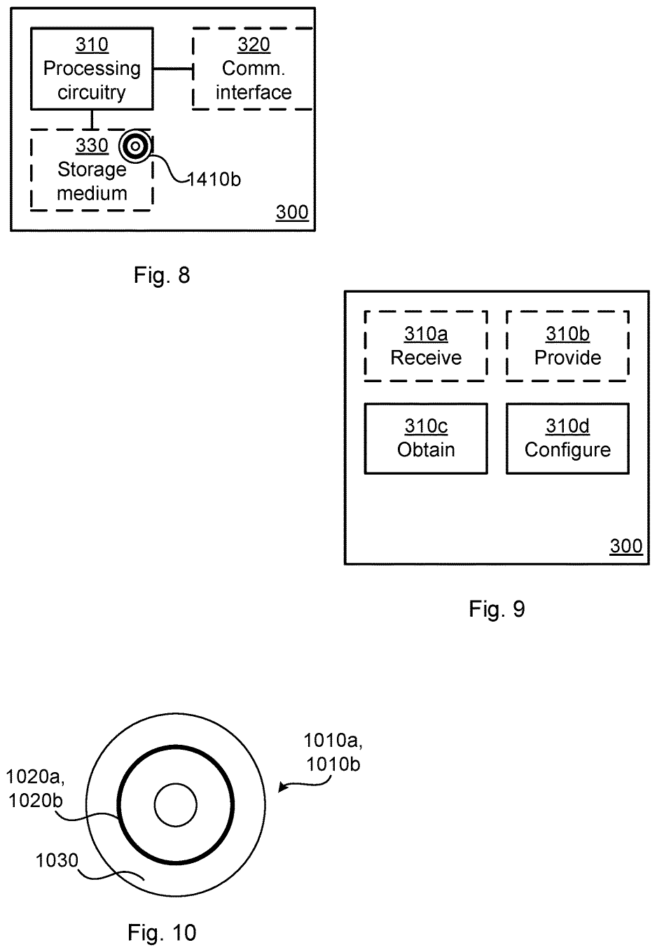

FIG. 8 schematically illustrates, in terms of a number of functional units, the components of a controller entity 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1010b (as in FIG. 10), e.g. in the form of a storage medium 330. The processing circuitry 310 may further be provided as at least one application specific integrated circuit (ASIC), or field programmable gate array (FPGA).

Particularly, the processing circuitry 310 is configured to cause the controller entity 300 to perform a set of operations, or steps, as disclosed above. For example, the storage medium 330 may store the set of operations, and the processing circuitry 310 may be configured to retrieve the set of operations from the storage medium 330 to cause the controller entity 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The controller entity 300 may further comprise a communications interface 320 for communications with other entities, functions, nodes, and devices, as in FIG. 1 and FIG. 2. As such the communications interface 320 may comprise one or more transmitters and receivers, comprising analogue and digital components.

The processing circuitry 310 controls the general operation of the controller entity 300 e.g. by sending data and control signals to the communications interface 320 and the storage medium 330, by receiving data and reports from the communications interface 320, and by retrieving data and instructions from the storage medium 330. Other components, as well as the related functionality, of the controller entity 300 are omitted in order not to obscure the concepts presented herein.

FIG. 9 schematically illustrates, in terms of a number of functional modules, the components of a controller entity 300 according to an embodiment. The controller entity 300 of FIG. 9 comprises a number of functional modules; an obtain module 310c configured to perform step S206, and a configure module 310d configured to perform step S108. The controller entity 300 of FIG. 9 may further comprise a number of optional functional modules, such as any of a receive module 310a configured to perform step S202, and a provide module 310b configured to perform step S204. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the controller entity 300 as disclosed herein.

FIG. 10 shows one example of a computer program product 1010a, 1010b comprising computer readable means 1030. On this computer readable means 1030, a computer program 1020a can be stored, which computer program 1020a can cause the processing circuitry 210 and thereto operatively coupled entities and devices, such as the communications interface 220 and the storage medium 230, to execute methods according to embodiments described herein. The computer program 1020a and/or computer program product 1010a may thus provide means for performing any steps of the network node 200a, 200b as herein disclosed. On this computer readable means 1030, a computer program 1020b can be stored, which computer program 1020b can cause the processing circuitry 310 and thereto operatively coupled entities and devices, such as the communications interface 320 and the storage medium 330, to execute methods according to embodiments described herein. The computer program 1020b and/or computer program product 1010b may thus provide means for performing any steps of the controller entity 300 as herein disclosed.

In the example of FIG. 10, the computer program product 1010a, 1010b is illustrated as an optical disc, such as a CD (compact disc) or a DVD (digital versatile disc) or a Blu-Ray disc. The computer program product 1010a, 1010b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020a, 1020b is here schematically shown as a track on the depicted optical disk, the computer program 1020a, 1020b can be stored in any way which is suitable for the computer program product 1010a, 1010b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for controlling a reflective intelligent surface, RIS, wherein the RIS comprises a controller entity and a reflector entity, wherein the reflector entity is associated with configurable reflection properties defining how radio waves that impinge the reflector entity are reflected, wherein the reflection properties are controlled by the controller entity, wherein the method is performed by a network node and wherein the method comprises:
determining that the RIS refrain from reflecting signals communicated in radio waves between the network node and a user equipment; and in response thereto:
providing an indication to the controller entity for the RIS to enter a non-relay mode according to which the reflector entity is to apply a default configuration of the reflection properties.

2. The method according to claim 1, wherein the method further comprises:
querying the controller entity for possible reflection settings that the reflector entity according to the reflection properties is capable of applying; and
receiving a response from the controller entity comprising the reflection settings, and wherein the default configuration is selected to correspond to one of the reflection settings.

3. The method according to claim 1, wherein the reflection settings define any of: a set of reflection angles, a set of reflection beam widths, or scattering capabilities of the reflector entity.

4. The method according to claim 1, wherein the indication comprises information of a time period during which the RIS is to be in the non-relay mode.

5. The method according to claim 1, wherein the reflector entity is configured to reflect the radio waves in reflection beams, and wherein the default configuration specifies the reflector entity to use as wide reflection beam as possible.

6. The method according to claim 1, wherein the default configuration specifies a direction of arrival and that direction of departure for the radio waves reflected by the reflector entity to be same as the direction of arrival.

7. The method according to claim 6, wherein the method further comprises:
performing self-calibration of the network node by transmitting a signal to be reflected back to the network node via the RIS.

8. The method according to claim 1, wherein the reflector entity comprises reflecting antenna elements in which the radio waves are reflected, and wherein the default configuration specifies the reflection elements to have uncorrelated reflection angles.

9. The method according to claim 1, wherein the default configuration specifies a default reflection angle and beam width.

10. The method according to claim 9, wherein the default reflection angle is by the network node determined based on positioning information of at least one of the network node, the RIS, and user equipment served by the network node.

11. The method according to claim 9, wherein the default reflection angle is by the network node determined, based on the positioning information, with an object for the RIS to avoid reflecting radio waves towards the network node and/or the user equipment.

12. The method according to claim 9, wherein the default reflection angle is by the network node determined for the network node to use MU-MIMO operation without the RIS acting as relay node.

13. The method according to claim 9, wherein the default reflection angle and beam width are by the network node determined based on reports from user equipment served by the network node of reference signals transmitted in beams from the network node.

14. The method according to claim 9, wherein the default reflection angle is by the network node determined based on measurements made by the network node on reference signals received by the network node from user equipment served by at least one further network node.

15. The method according to claim 9, wherein the default reflection angle and beam width is by the network node determined based on estimated interference as caused by the RIS to at least one further network node.

16. A method for controlling a reflective intelligent surface, RIS, wherein the RIS comprises a controller entity and a reflector entity, wherein the reflector entity is associated with configurable reflection properties defining how radio waves that impinge the reflector entity are reflected, wherein the reflection properties are controlled by the controller entity, wherein the method is performed by the controller entity and wherein the method comprises:
obtaining an indication that the RIS is to enter a non-relay mode according to which the reflector entity is to refrain from reflecting signals communicated in radio waves between a network node and a user equipment; and in response thereto:
configuring the reflector entity to apply a default configuration of the reflection properties.

17.-26. (canceled)

27. A network node for controlling a reflective intelligent surface, RIS, wherein the RIS comprises a controller entity and a reflector entity, wherein the reflector entity is associated with configurable reflection properties defining how radio waves that impinge the reflector entity are reflected, wherein the reflection properties are controlled by the controller entity, wherein the network node comprises processing circuitry, and wherein the processing circuitry is configured to cause the network node to:
determine that the RIS refrain from reflecting signals communicated in radio waves between the network node and a user equipment; and in response thereto:
provide an indication to the controller entity for the RIS to enter a non-relay mode according to which the reflector entity is to apply a default configuration of the reflection properties.

28.-29. (canceled)

30. A controller entity for controlling a reflective intelligent surface, RIS, wherein the RIS comprises the controller entity and a reflector entity, wherein the reflector entity is associated with configurable reflection properties defining how radio waves that impinge the reflector entity, are reflected, wherein the reflection properties are controlled by the controller entity, wherein the controller entity comprises processing circuitry, and wherein the processing circuitry is configured to cause the controller entity to:
obtain an indication that the RIS is to enter a non-relay mode according to which the reflector entity is to refrain from reflecting signals communicated in radio waves between a network node and a user equipment; and in response thereto:
configure the reflector entity to apply a default configuration of the reflection properties.

31.-32. (canceled)

33. A computer program product for controlling a reflective intelligent surface, RIS, wherein the RIS comprises a controller entity and a reflector entity, wherein the reflector entity is associated with configurable reflection properties defining how radio waves that impinge the reflector entity are reflected, wherein the reflection properties are controlled by the controller entity, wherein the computer program product comprises a non-transitory computer readable medium storing computer code which, when run on processing circuitry of a network node, causes the network node to:
carry out the method according to claim 1.

34. A computer program product for controlling a reflective intelligent surface, RIS, wherein the RIS comprises a controller entity and a reflector entity, wherein the reflector entity is associated with configurable reflection properties defining how radio waves that impinge the reflector entity are reflected, wherein the reflection properties are controlled by the controller entity, and wherein the computer program product comprises a non-transitory computer readable medium storing computer code which, when run on processing circuitry of the controller entity, causes the controller entity to:
carry out the method according to claim 16.

35. (canceled)
